(19) United States
(12) Patent Application Publication
(10) Pub. No.: US 2024/0340817 A1
(43) Pub. Date: Oct. 10, 2024

(54) COMMUNICATION DEVICE, METHOD FOR CONTROLLING COMMUNICATION DEVICE, AND STORAGE MEDIUM

(71) Applicant: CANON KABUSHIKI KAISHA, Tokyo (JP)

(72) Inventor: Kohtaro Koike, Kanagawa (JP)

(21) Appl. No.: 18/746,243

(22) Filed: Jun. 18, 2024

Related U.S. Application Data
(63) Continuation of application No. PCT/JP2022/043670, filed on Nov. 28, 2022.

(30) Foreign Application Priority Data
Jan. 31, 2022 (JP) 2022-013584

(51) Int. Cl. H04W 56/00

(52) U.S. Cl. CPC H04W 56/001

(57) ABSTRACT

A communication device that forms a network with another communication device, the communication device comprising: a determination unit configured to determine whether or not a base station outside the network supports time synchronization with predetermined precision, based on information relating to time synchronization received from the base station; a time synchronization processing unit configured to synchronize time in the communication device with time in the base station, in a case where the base station supports time synchronization with the predetermined precision; and a control unit configured to control the communication device, wherein, in a case where the time in the communication device is synchronized with the time in the base station, the control unit causes the communication device to operate as a time synchronization source for the other communication device included in the network.

### CROSS-REFERENCE TO RELATED APPLICATIONS

This application is a Continuation of International Patent Application No. PCT/JP2022/043670, filed Nov. 28, 2022, which claims the benefit of Japanese Patent Application No. 2022-013584 filed Jan. 31, 2022, both of which are hereby incorporated by reference herein in their entirety.

### BACKGROUND OF THE INVENTION

### Field of the Invention

The present invention relates to a communication device, a method for controlling the communication device, and a storage medium.

### Background Art

When time synchronization is performed in a network formed between devices, a device included in the network may obtain time information from a device outside the network and time synchronization may be performed in the network with use of the obtained time information.

For example, a network is formed between a plurality of cameras, and a camera included in the network obtains time information from the outside of the network. If the time is synchronized between the cameras included in the network, the efficiency of edition work can be increased, e.g., it is possible to arrange a plurality of images taken by a plurality of users in chronological order. Specific examples of the device outside the network include the GPS, a radio clock, and a high-precision clock that transmits synchronization signals via a cable (PTL 1).

Also, studies are currently carried out to enable high-precision time synchronization in a 5G base station with use of the PTP (Precision Time Protocol) in accordance with the IEEE (Institute of Electrical and Electronics Engineers) (registered trademark) 1588 standard.

### CITATION LIST

### Patent Literature

PTL 1: Japanese Patent Laid-Open No. 2009-111654

In PTL 1, synchronization signals are received from the GPS or a radio clock or from a high-precision clock via a cable. However, time synchronization cannot be performed indoors with use of the GPS because positioning cannot be performed indoors. Also, it is unclear whether or not the precision of received time is high enough to be acceptable for the user.

Also, high-precision time synchronization can be realized by accessing a 5G base station that supports the PTP described above, but if an accessed base station does not support the PTP, high-precision time synchronization cannot be realized although the base station is accessed with an expectation of performing the high-precision time synchronization.

The present invention was made in view of the above problems and provides a technology for stably realizing time synchronization with predetermined precision.

### SUMMARY OF THE INVENTION

According to one aspect of the present invention, there is provided a communication device that forms a network with another communication device, the communication device comprising: a determination unit configured to determine whether or not a base station outside the network supports time synchronization with predetermined precision, based on information relating to time synchronization received from the base station; a time synchronization processing unit configured to synchronize time in the communication device with time in the base station, in a case where the base station supports time synchronization with the predetermined precision; and a control unit configured to control the communication device, wherein, in a case where the time in the communication device is synchronized with the time in the base station, the control unit causes the communication device to operate as a time synchronization source for the other communication device included in the network.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram showing an example of a hardware configuration of a communication device according to an embodiment.

FIG. 2 is a block diagram showing an example of a software configuration of the communication device according to an embodiment.

FIG. 3 is a diagram showing a configuration example of a communication system according to an embodiment.

FIG. 4 is a flowchart showing a procedure of processing performed by the communication device according to an embodiment when a grandmaster is established in a local network.

FIG. 5 is a flowchart showing a procedure of processing performed by the communication device according to an embodiment after the grandmaster is established in the local network.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Hardware Configuration

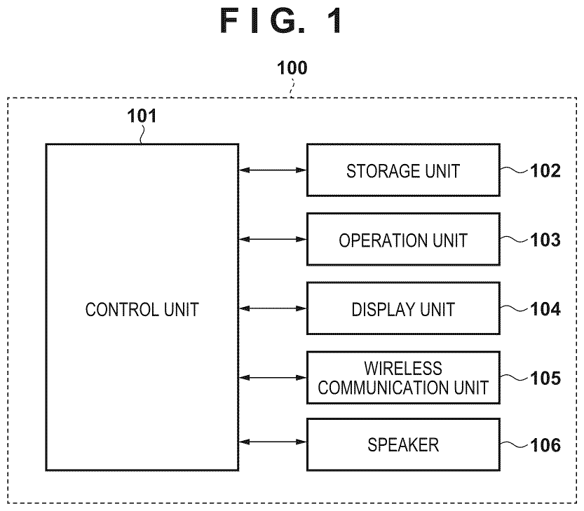

FIG. 1 is a block diagram showing an example of a hardware configuration of a communication device according to an embodiment. A communication device 100 includes a control unit 101, a storage unit 102, an operation unit 103, a display unit 104, a wireless communication unit 105, and a speaker 106.

The control unit 101 is one or more CPUs (Central Processing Units), for example, and controls operations of elements of the communication device 100 in accordance with a signal that is input or a program, which will be described later. Instead of the configuration in which the control unit 101 controls the entire device, a configuration is also possible in which a plurality of pieces of hardware share processing to control the entire device. One or more control programs executed by the control unit 101 and various types of information such as communication parameters and captured image data are stored in the storage unit 102. Various operations described below are performed as a result of the control unit 101 executing the one or more control programs stored in the storage unit 102.

The operation unit 103 is used to accept instructions to the communication device 100 from a user. The operation unit is a physical operation unit such as a keyboard or a physical button, for example. Alternatively, if the display unit 104 functions as a touch panel that accepts touch operations, the display unit 104 may also be used as the operation unit.

The operation unit 103 accepts a selection operation for causing the communication device 100 to operate as a master device that operates as an access point in a wireless LAN or a slave device that operates as a station in the wireless LAN. Also, the operation unit 103 can accept setting of a first mode (power saving mode) in which the communication device 100 operates in a power saving state or a second mode (normal operation mode) in which the communication device 100 does not operate in the power saving state.

The display unit 104 performs various types of display and has a function of outputting visually recognizable information like an LCD (Liquid Crystal Display) and an LED (Light Emitting Diode).

The wireless communication unit 105 performs wireless LAN communication in accordance with a 3GPP (Third Generation Partnership Project) (registered trademark) standard or the IEEE (Institute of Electrical and Electronics Engineers) (registered trademark) 802.11a/b/g/n/ac/ax (registered trademark) standards. The speaker 106 is a notification unit capable of outputting audio information.

### Software Configuration

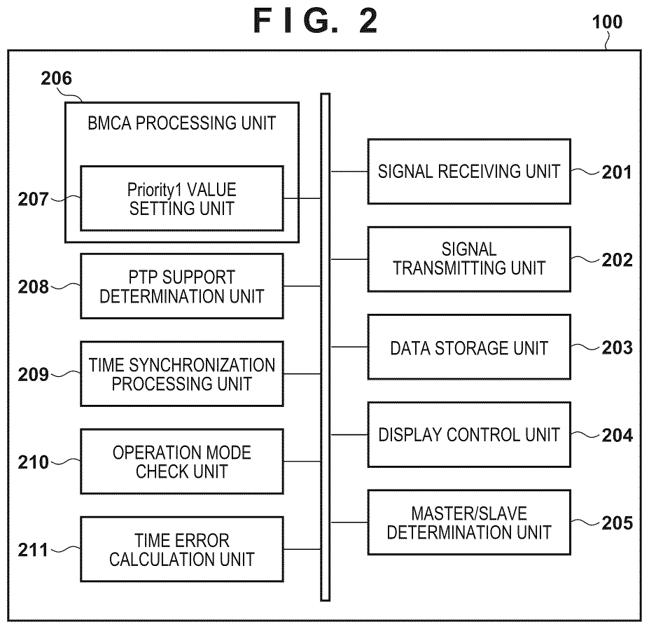

FIG. 2 is a block diagram showing an example of a software configuration of the communication device 100 according to an embodiment. The communication device 100 includes a signal receiving unit 201, a signal transmitting unit 202, a data storage unit 203, and a display control unit 204. The communication device 100 also includes a master/slave determination unit 205, a BMCA processing unit 206, a PTP support determination unit 208, a time synchronization processing unit 209, an operation mode check unit 210, and a time error calculation unit 211. The BMCA processing unit 206 includes a Priority 1 value setting unit 207.

The signal receiving unit 201 receives wireless LAN signals from a device and the signal transmitting unit 202 transmits wireless LAN signals to the device in accordance with the 3GPP (registered trademark) standard or the IEEE 802.11a/b/g/n/ac/ax (registered trademark) standards. The signal receiving unit 201 and the signal transmitting unit 202 correspond to the wireless communication unit 105. The data storage unit 203 corresponds to the storage unit 102 and stores software itself and information such as authentication information therein.

The display control unit 204 performs processing for controlling screens displayed on the display unit 104. The master/slave determination unit 205 determines whether the communication device is operating as a master device or a slave device in the network. Note that the master device operates as an access point in the wireless LAN, and the slave device operates as a station in the wireless LAN.

The BMCA processing unit 206 operates based on the BMCA (Best Master Clock Algorithm) that automatically determines the optimum grandmaster from among a plurality of candidates for the grandmaster. The BMCA processing unit 206 includes the Priority 1 value setting unit 207. The Priorityl value is information that is compared between the plurality of candidates for the grandmaster with preference over any other information when the grandmaster is determined based on the BMCA. The Priorityl value is a value within the range from 0 to 255, and a device that has the smallest Priority 1 value is determined as the grandmaster.

The PTP support determination unit 208 determines whether or not a base station 500, which will be described later, supports the IEEE (registered trademark) 1588. The time synchronization processing unit 209 performs time synchronization processing to synchronize the time with the base station 500, which will be described later, and communication devices 300 and 301. Specifically, the time synchronization processing unit performs time synchronization processing in accordance with the IEEE (registered trademark) 1588 standard or the RFC (Request for Comments) (registered trademark) 1305.

The operation mode check unit 210 checks an operation mode of the communication device. The operation mode is any of a plurality of operation modes including the power saving mode in which power consumption is suppressed and the normal mode in which power consumption is not suppressed. The time error calculation unit 211 calculates a time error between the communication device and the base station 500, which will be described later.

### System Configuration

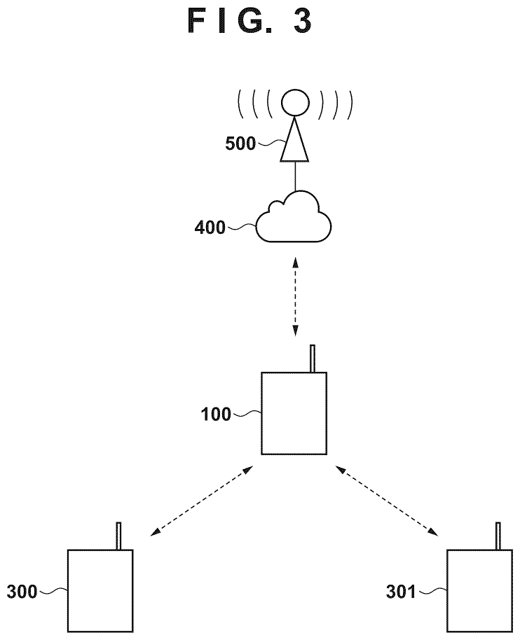

FIG. 3 is a diagram showing a configuration example of a communication system according to an embodiment. The communication system according to the present embodiment includes the communication device 100, the communication device 300, the communication device 301, a public network 400, and the base station 500. The communication device 100 performs communication with the public network 400 in accordance with the 3GPP (registered trademark) standard and performs communication with the communication devices 300 and 301 in accordance with Wi-Fi (registered trademark). Note that the communication devices 300 and 301 have the same configuration as the communication device 100, and therefore, descriptions thereof are omitted.

### Processing

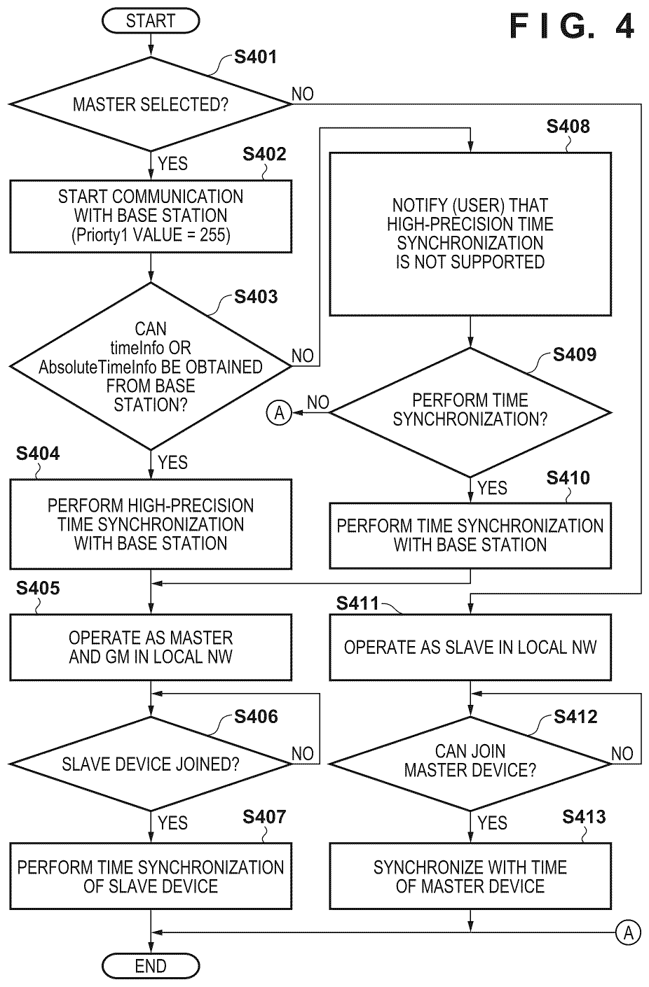

FIG. 4 is a flowchart showing a procedure of processing performed when the communication device 100 is established as a grandmaster in a network formed between communication devices in the present embodiment. Upon the operation unit 103 of the communication device 100 accepting an operation for setting the communication device as a master device or a slave device, a notification is given to the control unit 101.

The control unit 101 determines whether or not the communication device 100 is selected as the master device, by using the master/slave determination unit 205 (S401). If the communication device 100 is selected as the master device, the communication device 100 operates as an access point of a wireless LAN. The control unit 101 boots the wireless communication unit 105, sets the Priority 1 value to 255 by using the Priority 1 value setting unit 207, and then causes the wireless communication unit 105 to start communication with the base station 500 in accordance with the 3GPP standard (registered trademark) (S402).

Here, the Priority 1 value is set to 255, which is the maximum value, to prevent the communication device 100 from becoming a grandmaster in a network formed by the base station 500 outside the network based on the BMCA when the communication device 100 accesses the base station 500. The wireless communication unit 105 gives a notification to the control unit 101 upon receiving system information transmitted from the base station 500 as a notification signal, or an RRC (Radio Resource Control) message transmitted between the communication device and the base station 500.

The control unit 101 checks whether or not a parameter called “TimeInfo”, which will be described later, is included in SIB (System Information Block) 9, which is a block included in the received system information, by using the PTP support determination unit 208. Furthermore, the control unit 101 checks whether or not “AbsoluteTimeInfo”, which will be described later, is included in the received RRC message (S403).

The TimeInfo includes the following four items: “TimeInfoUTC” (essential), “DayLightSavingTime” (optional), “LeapSeconds” (optional), and “LocalTimeOffset” (optional). If only the essential item is included, it is possible to obtain UTC (Coordinated Universal Time) time information. If the optional items are also included, it is possible to obtain time with precision equivalent to the precision of time obtained from the GPS. However, the time included in the TimeInfo does not include communication delay that occurs in communication between the base station 500 and the communication device 100. The AbsoluteTimeInfo indicates an absolute time composed of year, month, date, hour, minute, and second.

Upon confirming that the TimeInfo or the AbsoluteTimeInfo is included, the control unit 101 determines that it is possible to perform time synchronization with predetermined precision with the base station 500 outside the network and starts the time synchronization (S404). In this case, the control unit 101 performs time synchronization processing in accordance with the IEEE (registered trademark) 1588 standard with the base station 500 via the wireless communication unit 105 by using the time synchronization processing unit 209. The control unit 101 stores, in the storage unit 102, information indicating that the communication device 100 is the master device and a grandmaster in the network formed between the communication devices (S405). After this, the communication device 100 operates as the master device and the grandmaster device in the network formed between the communication devices. That is to say, when the time in the communication device 100 is synchronized with the time in the base station 500, the control unit 101 causes the communication device 100 to operate as a time synchronization source for the other communication devices 300 and 301 included in the network.

The control unit 101 waits for access from the communication devices 300 and 301 to the communication device 100 via the wireless communication unit 105 (S406). Upon the communication devices 300 and 301 accessing the communication device 100, the control unit 101 performs time synchronization processing with the communication devices 300 and 301 via the wireless communication unit 105 by using the time synchronization processing unit 209 (S407). Thus, time synchronization between the communication devices is completed.

On the other hand, if the presence of both the TimeInfo and the AbsoluteTimeInfo cannot be confirmed in step S403, the processing proceeds to step S408. Then, the control unit 101 determines that time synchronization processing in accordance with the IEEE (registered trademark) 1588 standard cannot be performed with the base station 500 and gives a notification indicating the determination result via the display unit 104 (S408). The display control unit 204 controls the display unit 104 to display information indicating that time synchronization processing in accordance with the IEEE (registered trademark) 1588 standard cannot be performed and information for letting the user select whether or not to perform time synchronization with the base station 500 although the time synchronization processing cannot be performed in accordance with the IEEE 1588 standard. Instead of or in addition to this, it is possible to give an audio notification by using the speaker 106.

Then, the control unit 101 determines whether or not to perform time synchronization based on the selection of the user (S409). If the user wants to perform time synchronization with the base station 500, the user selects performing time synchronization, by using the operation unit 103, and the control unit 101 is notified of the selection result. The control unit 101 performs time synchronization processing in accordance with the RFC (registered trademark) 1305 with the base station 500 via the wireless communication unit 105 by using the time synchronization processing unit 209 (S410). Thereafter, processing similar to the processing performed in steps S405 to S407 is performed.

If it is determined in step S401 that the communication device 100 is selected as the slave device, the processing proceeds to step S411. The communication device 100 operates as the slave device in the network formed between the communication devices (S411). In this case, the communication device 100 operates as a station in the wireless LAN. Thereafter, the control unit 101 searches for a communication device (e.g., the communication device 300 or 301) that functions as the master device via the wireless communication unit 105 (S412). Upon detecting a communication device that functions as the master device, the processing proceeds to step S413. The control unit 101 performs time synchronization processing with the communication device that functions as the master device via the wireless communication unit 105 by using the time synchronization processing unit 209 (S413).

Here, if the user selects not performing time synchronization with the base station 500 in step S409, the operation unit 103 notifies the control unit 101 of the selection. Upon receiving the notification, the control unit 101 stops the wireless communication unit 105. The series of processing shown in FIG. 4 is performed as described above.

Note that a configuration is also possible in which time synchronization with the base station 500 is not performed in steps S404 and S410, and time information is obtained from the TimeInfo or the AbsoluteTimeInfo, which is obtained in step S403, and set in the time synchronization processing unit 209. However, in this case, an error corresponding to the time it takes for communication between the communication device 100 and the base station 500 may occur.

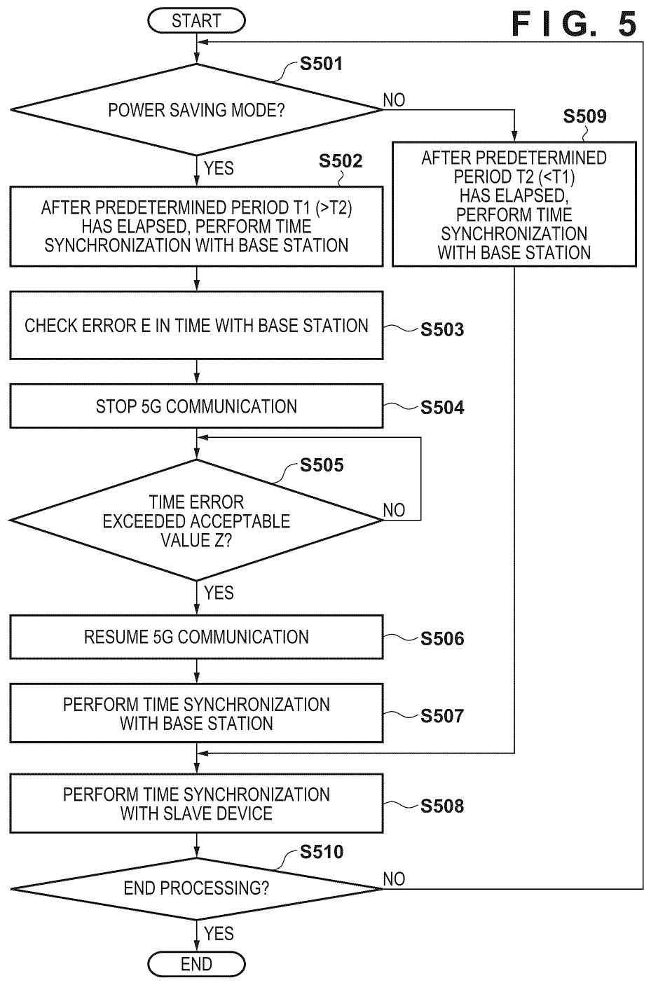

Next, FIG. 5 is a flowchart showing a procedure of processing performed after the communication device 100 is established as the grandmaster in the network formed between the communication devices according to an embodiment.

The operation unit 103 can accept setting of the first mode (power saving mode) in which the communication device 100 operates in the power saving state or the second mode (normal operation mode) in which the communication device 100 does not operate in the power saving state. If an operation mode (e.g., the power saving mode or the normal operation mode) of the communication device 100 is set by the operation unit 103, the control unit 101 stores the operation mode in the storage unit 102. Note that the operation mode may also be set before the communication device 100 is selected as the grandmaster.

The control unit 101 determines whether or not the operation mode currently set in the communication device 100 is the power saving mode for suppressing power consumption, by using the operation mode check unit 210 (S501). If the power saving mode is set, the control unit 101 performs time synchronization with the base station 500 via the wireless communication unit 105 by using the time synchronization processing unit 209 after a predetermined period T1 has elapsed (S502).

Here, the predetermined period T1 is a first predetermined period that is measured from the previous time synchronization, for example. The control unit 101 checks an error E between time in the communication device 100 before the time synchronization performed in step S502 and time in the communication device 100 after the time synchronization by using the time error calculation unit 211 and stores the error E in the storage unit 102 (S503). After checking the error, the control unit 101 stops the function of the wireless communication unit 105 for performing communication in accordance with the 3GPP standard (S504).

The control unit 101 keeps stopping the operation of the wireless communication unit 105 until a time error with respect to the base station 500 exceeds an acceptable value Z (S505). That is to say, the control unit 101 determines whether or not the time error has exceeded the acceptable value Z and waits for the time error exceeding the acceptable value Z. More specifically, the control unit 101 calculates a time error E/T1=Y per unit time with respect to the base station 500 based on the predetermined period T1 that elapsed in step S502 and the time error E checked in step S503, by using the time error calculation unit 211. The time error increases by Y per unit time, and therefore, the control unit 101 determines whether or not a total value of the error that has increased with the passage of time has exceeded the acceptable value Z by using the time error calculation unit 211.

As described above, the control unit 101 calculates the value of time error that occurs per unit time based on the predetermined period T1 and the time error E that occurred with the passage of the predetermined period T1 and calculates a current time error based on the value and a period that elapsed from execution of the time synchronization. Then, the control unit 101 determines whether or not the current time error is larger than the acceptable value Z.

If the error is larger than the acceptable value Z, it is necessary to perform time synchronization, and therefore, the control unit 101 boots the function of the wireless communication unit 105 for performing communication in accordance with the 3GPP standard and causes the wireless communication unit 105 to resume communication with the base station 500 (S506).

The control unit 101 performs time synchronization with the base station 500 via the wireless communication unit 105 by using the time synchronization processing unit 209 (S507). Thereafter, the control unit 101 performs time synchronization with the communication devices 300 and 301 via the wireless communication unit 105 by using the time synchronization processing unit 209 in the network of the communication devices (S508). Thereafter, the control unit 101 determines whether or not to end the processing (S510), and upon determining not to end the processing, returns to step S501 and repeats the processing. The control unit 101 ends the processing in a case where the power source of the communication device 100 is turned off through an operation made by the user or an input for stopping the time synchronization processing has been accepted, for example.

On the other hand, when it is determined in step S501 that a mode (e.g., the normal operation mode) other than the power saving mode is set in the communication device 100, the processing proceeds to step S509. The control unit 101 performs time synchronization with the base station 500 via the wireless communication unit 105 by using the time synchronization processing unit 209 after a predetermined period T2 that is shorter than the predetermined period T1, which elapsed in step S502, has elapsed (S509).

Here, the predetermined period T2 is a second predetermined period that is measured from the previous time synchronization, for example, and satisfies T1>T2. That is to say, when the communication device is operating in the power saving mode, power consumption can be further suppressed by reducing the frequency of the time synchronization with the base station 500. On the other hand, when a mode (e.g., the normal operation mode) other than the power saving mode is set, time information of the communication device 100 can be kept at more accurate values by increasing the frequency of the time synchronization. Thereafter, the processing proceeds to step S508. The series of processing shown in FIG. 5 is performed as described above.

As described above, in the present embodiment, the communication device 100 performs time synchronization with the base station 500 after determining whether or not the time synchronization can be performed with predetermined precision based on communication performed with the base station 500. Therefore, the user can confirm whether or not time synchronization can be performed with desired precision before the time synchronization, and then perform the time synchronization.

As described above, according to the present embodiment, it is possible to stably realize time synchronization with predetermined precision. Also, it is possible to avoid a situation in which time synchronization cannot be realized with the predetermined precision although the base station is accessed with an expectation of performing time synchronization with the predetermined precision.

According to the present invention, it is possible to stably realize time synchronization with predetermined precision.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device that forms a network with another communication device, the communication device comprising:
a determination unit configured to determine whether or not a base station outside the network supports time synchronization with predetermined precision, based on information relating to time synchronization received from the base station;
a time synchronization processing unit configured to synchronize time in the communication device with time in the base station, in a case where the base station supports time synchronization with the predetermined precision; and
a control unit configured to control the communication device,
wherein, in a case where the time in the communication device is synchronized with the time in the base station, the control unit causes the communication device to operate as a time synchronization source for the other communication device included in the network.

2. The communication device according to claim 1, wherein the base station is a base station according to a 3GPP (Third Generation Partnership Project) standard, and wherein the network is a network that is based on a communication standard different from the 3GPP standard.

3. The communication device according to claim 1, further comprising:
an operation unit configured to accepting an operation made by a user,
wherein the operation unit accepts a selection operation for causing the communication device to operate as a master device that operates as an access point in a wireless LAN or a slave device that operates as a station in the wireless LAN.

4. The communication device according to claim 3, further comprising:
a communication unit configured to communicate with the base station in a case where the communication device is selected as the master device.

5. The communication device according to claim 4, wherein
the communication unit communicates with the base station after setting Priority 1 value of PTP (Precision Time Protocol) to 255, which is a maximum value.

6. The communication device according to claim 4, wherein
in a case where TimeInfo is included in SIB (System Information Block) 9 received from the base station via the communication unit, the determination unit determines that the base station supports time synchronization with the predetermined precision.

7. The communication device according to claim 4, wherein
in a case where AbsoluteTimeInfo is included in an RRC (Radio Resource Control) message received from the base station via the communication unit, the determination unit determines that the base station supports time synchronization with the predetermined precision.

8. The communication device according to claim 1, wherein
in a case where it is determined by the determination unit that the base station does not support time synchronization with the predetermined precision, the control unit causes display unit to display information indicating that the base station does not support time synchronization with the predetermined precision.

9. The communication device according to claim 1, wherein
in a case where the time in the communication device is synchronized with the time in the base station, the control unit causes the communication device to operate as a master device and a grandmaster in the network for the other communication device included in the network.

10. The communication device according to claim 3, wherein
the operation unit is capable of accepting setting of a first mode in which the communication device operates in a power saving state or a second mode in which the communication device does not operate in the power saving state.

11. The communication device according to claim 10, wherein
in a case where the communication device operates as the time synchronization source in the first mode, the time synchronization processing unit performs time synchronization with the base station after a first predetermined period has elapsed, and
in a case where the communication device operates as the time synchronization source in the second mode, the time synchronization processing unit performs time synchronization with the base station after a second predetermined period that is shorter than the first predetermined period has elapsed.

12. The communication device according to claim 11, wherein
the control unit checks a time error occurring between the base station and the communication device after time synchronization with the base station performed after the first predetermined period has elapsed and stops communication with the base station.

13. The communication device according to claim 12, wherein
the control unit calculates a value of time error that occurs per unit time based on the first predetermined period and a time error that occurred with passage of the first predetermined period,
calculates a current time error based on the value and a period that elapsed from execution of time synchronization, and
in a case where the current time error is larger than an acceptable value, resumes communication with the base station.

14. The communication device according to claim 13, wherein
in a case where communication with the base station is resumed, the time synchronization processing unit performs time synchronization with the base station.

15. A method for controlling a communication device that forms a network with another communication device, the method comprising:
determining whether or not a base station outside the network supports time synchronization with predetermined precision, based on information relating to time synchronization received from the base station;
synchronizing time in the communication device with time in the base station, in a case where the base station supports time synchronization with the predetermined precision; and
controlling the communication device,
wherein, in the controlling, in a case where the time in the communication device is synchronized with the time in the base station, the communication device is caused to operate as a time synchronization source for the other communication device included in the network.

16. A non-transitory computer readable storage medium storing a program for causing a computer to perform a method for controlling a communication device that forms a network with another communication device, the method comprising:
determining whether or not a base station outside the network supports time synchronization with predetermined precision;
synchronizing time in the communication device with time in the base station, in a case where the base station supports time synchronization with the predetermined precision; and
controlling the communication device,
wherein, in the controlling, in a case where the time in the communication device is synchronized with the time in the base station, the communication device is caused to operate as a time synchronization source for the other communication device included in the network.
